(19) United States
(12) Patent Application Publication
(10) Pub. No.: US 2016/0004598 A1
(43) Pub. Date: Jan. 7, 2016

(54) GROUPING CHUNKS OF DATA INTO A COMPRESSION REGION

(71) Applicant: HEWLETT-PACKARD DEVELOPMENT COMPANY, L.P., Houston, TX (US)

(72) Inventors: Mark Lillibridge, Palo Alto, CA (US); Joseph Tucek, Palo Alto, CA (US)

(21) Appl. No.: 14/765,183

(22) PCT Filed: Apr. 30, 2013
(86) PCT No.: PCT/US2013/038870

§ 371 Date: Jul. 31, 2015

(51) Int. Cl. G06F 11/14; G06F 17/30

(52) U.S. Cl. CPC G06F 11/1402; G06F 17/30153; G06F 17/30412

(57) ABSTRACT

Examples disclosed herein relate to grouping chunks of data into a compression region. Examples relate to a chunk container comprising a first plurality of chunks of data in a plurality of first compression regions, and include grouping a second plurality of the chunks into a second compression region, and compressing the chunks of the second compression region relative to each other.

### BACKGROUND

A computer system may generate a large amount of data, which may be stored locally by the computer system. Loss of such data resulting from a failure of the computer system, for example, may be detrimental to an enterprise, individual, or other entity utilizing the computer system. To protect the data from loss, a data backup system may store at least a portion of the computer system's data. In such examples, if a failure of the computer system prevents retrieval of some portion of the data, it may be possible to retrieve the data from the data backup system.

### BRIEF DESCRIPTION OF THE DRAWINGS

The following detailed description references the drawings, wherein:

FIG. 1 is a block diagram of an example system to group chunks into a compression region based on supplemental order information;

FIG. 2A is a diagram of example backup streams of a backup system at least partially implemented by the system of FIG. 1;

FIG. 2B is a diagram of an example chunk container storing chunks of the backup streams of FIG. 2A;

FIGS. 2C-2G illustrate an example of grouping chunks into a compression region based on supplemental order information with the system of FIG. 1;

FIG. 2H is a block diagram of a chunk container including manifest pointers;

FIG. 3 is a block diagram of an example computing device to group chunks into a compression region based on similarity among the data of the chunks and based on supplemental order information;

FIGS. 4A-4F illustrate an example of grouping chunks into a compression region based on similarity and supplemental order information with the computing device of FIG, 3;

FIG. 5 is a flowchart of an example method for grouping similar chunks into a compression region; and

FIG. 6 is a flowchart of an example method for grouping chunks into a compression region based on similarity and supplemental order information.

### DETAILED DESCRIPTION

The design and implementation of a data backup system may involve tradeoffs between performance and cost of implementation. For example, techniques such as data deduplication and compression may enable backup data to be stored in the system more compactly and thus more cheaply. However, increased deduplication and compression may reduce the speed at which the data may be retrieved from the data backup system (referred to herein as “restore speed”), since retrieving the backup data involves restoring the backup data to its full and decompressed form.

In a backup system that performs deduplication on backup data, the backup system may divide a sequence of input data into an ordered collection of non-overlapping chunks of data, which may be referred to herein as a “backup stream”. A backup system that performs deduplication may generally store each unique chunk of one or more backup streams once. In examples described herein, a “chunk” of data is a portion of a sequence of data, such as a sequence of data input to a backup system. In some examples, chunks may have a mean size of about 4-8 kilobytes (KB). In other examples, chunks may be of any other suitable size. In some examples, a backup system may store chunks in chunk containers. In examples described herein, a “chunk container” may be a data structure to store one or multiple chunks. A container may be implemented as a discrete file or object, for example. In some examples, a chunk container may have a maximum size in the range of several megabytes (MB). In other examples, chunk containers may have any other suitable maximum size.

In addition to deduplication, backup systems may also perform compression on data to be stored. In some examples, a backup system may compress each chunk individually. Compressing larger units of data may generally produce better compression with a general purpose compressor; however, since data requested (e,g., retrieved) from a backup system is decompressed before it is output by the backup system, compressing larger units of data may lead to more time being wasted decompressing data that is not to be output. In some examples, a backup system may group chunks of a chunk container into one or more compression regions, and may compress each compression region independently. In such examples, compressing chunks in compression regions of a chunk container may strike a balance between efficient compression and restore speed. In examples described herein, a “compression region” may be a group of one or more chunks, adjacent in a chunk container, which are compressed or are to be compressed relative to each other and independent of any other chunks. For example, the chunks of a compression region may be compressed independent of the chunks of each other compression region of the chunk container. In some examples, a compression region may have a maximum size in the range of about 128 KB. In other examples, compression regions may have any other suitable maximum size.

In some examples, chunks initially may be added to a chunk container in the order in which they appear in a backup stream, and initial compression regions may be formed of groups of adjacent chunks in a chunk container. However, in some examples, chunks of a subsequent backup stream may be added to the chunk container because in the subsequent backup stream they are proximate to chunks already stored in the chunk container. In such examples, the chunks of the subsequent backup stream may be stored in new compression region(s) different from the initial compression region(s) including the chunks already stored in the chunk container. For example, a first backup stream may comprise a first group of chunks including data input to the backup system on a first day. This first group of chunks may be placed in a first compression region of a chunk container for storage. The first group of chunks may be, for example, a portion of a file that is changed often (e,g., daily). In such examples, modifications to the file made over several days may be stored in new chunks and grouped into new compression regions of the chunk container. However, the chunks representing unmodified portions of the file may not be stored again in the new compression regions as a result of deduplication in the backup system. As such, when the file is later retrieved from the backup system, the backup system may decompress all the different compression regions containing at least one chunk of the file (e.g., the first compression region and each subsequent compression region storing a modification of the file), which may be detrimental to restore speed.

To address these issues, examples described herein may rearrange chunks of a chunk container to group into a compression region chunks that are likely to be retrieved together. Examples described herein may include memory to store a chunk container comprising a first plurality of chunks of data in a plurality of first compression regions, and may group a second plurality of the chunks into a second compression region for the chunk container based on supplemental order information. In some examples, the supplemental order information may specify, for at least one pair of the chunks of the first plurality, a proximity relationship for the pair of chunks in an ordered collection of chunks different than and at least partially stored in the chunk container. The ordered collection of chunks may be a backup stream, for example. By grouping chunks into a compression region based on proximity in a backup stream, examples described herein may group into the compression region chunks likely to be retrieved together and may thereby improve restore speed. For example, chunks representing the above-described file modifications are likely to appear in a backup stream proximate to chunks representing unmodified portions of the file, and the supplemental order information may specify these proximity relationships. Accordingly, by grouping chunks into a second compression region based on proximity relationship(s) specified by the supplemental order information, examples described herein may group into the compression region chunks likely to be retrieved together.

Another issue with forming compression regions based on adjacency of chunks placed in a chunk container, as described above, is that it may cause the backup system to miss a significant amount of possible compression. For example, the chunks representing the modifications to the file may share data with each other and with chunks representing unmodified portions. While compression techniques may be able to compress such shared data if grouped in the same compression region, much of this possible compression may be missed of these chunks are placed in different compression regions. To address these issues, examples described herein may also group a plurality of the chunks of a chunk container into a compression region based on similarity among the data of the chunks. In this manner, examples described herein may improve compression of the chunk container since the similar chunks may be compressed against each other and yield improved rates of compression.

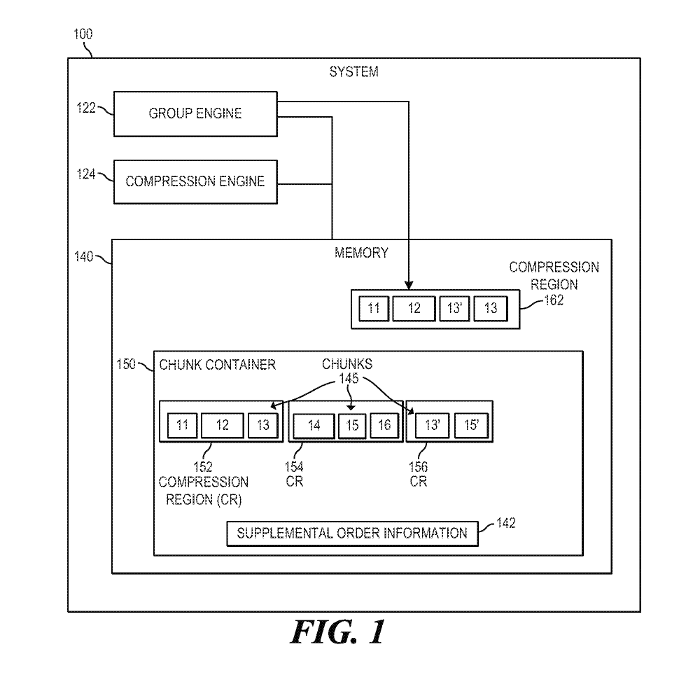

Referring now to the drawings, FIG. 1 is a block diagram of an example system 100 to group chunks into a compression region based on supplemental order information. In the example of FIG. 1, system 100 includes engines 122 and 124 in communication with memory 140. Memory 140 may be any type of machine-readable storage medium, in some examples, system 100 may include additional engine(s). As used herein, a “machine-readable storage medium” may be any electronic, magnetic, optical, or other physical storage apparatus to contain or store information such as executable instructions, data, and the like. For example, any machine-readable storage medium described herein may be any of a storage drive (e,g., a hard drive), flash memory, Random Access Memory (RAM), any type of storage disc (e.g., a Compact Disc Read Only Memory (CD-ROM), any other type of compact disc, a DVD, etc.), and the like, or a combination thereof. Further, any machine-readable storage medium described herein may be non-transitory.

In the example of FIG. 1, system 100 may be implemented by one or more computing devices. As used herein, a “computing device” may be a server, computer networking device, chip set, desktop computer, notebook computer, workstation, or any other processing device or equipment. In the example of FIG. 1, a computing device at least partially implementing system 100 may include at least one processing resource. In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof.

Memory 140 may store a chunk container 150 comprising a first plurality 145 of chunks of data. In the example of FIG. 1, the first plurality 145 of chunks may include chunks 11-16, 13′, and 15′. As shown in FIG. 1, the chunks of first plurality 145 may be of different sizes. Chunk container 150 may include the first plurality 145 of chunks in a plurality of first compression regions of chunk container 150. The first compression regions may comprise a compression region 152 including chunks 11-13, a compression region 154 including chunks 14-16, and a compression region 156 including chunks 13′ and 15′. In examples described herein, reference symbols used to designate individual chunks (e.g. “11”, “12”, etc.) are labels for the purpose of illustration and are not included in the chunks themselves. However, for the purpose of illustration, chunks labeled with the same reference symbol (e.g., “11”) indicate chunks comprising the same data, and chunks labeled with different reference symbols indicate chunks comprising data that differs at least in part. In other examples, chunk container 150 may include a different number of compression regions, a different number of chunks, a different grouping of chunks into compression regions, or a combination thereof. Although one chunk container is illustrated in FIG. 1, system 100 may store chunks in any suitable number of chunk containers, some or all of which may be stored in memory 140.

Each of engines 122 and 124, and any other engines of system 100, may be any combination of hardware and programming to implement the functionalities of the respective engine. Such combinations of hardware and programming may be implemented in a number of different ways. For example, the programming may be processor executable instructions stored on a non-transitory machine-readable storage medium and the hardware may include a processing resource to execute those instructions. In such examples, the machine-readable storage medium may store instructions that, when executed by the processing resource, implement the engines of system 100.

The machine-readable storage medium storing the instructions may be integrated in the same computing device as the processing resource to execute the instructions, or the machine-readable storage medium may be separate from but accessible to the computing device and the processing resource. The machine-readable storage medium storing the instructions may be separate from memory 140, or may be implemented by memory 140. The processing resource may comprise one processor or multiple processors included in a single computing device or distributed across multiple computing devices. Also, in some examples, memory 140 may be integrated in the same computing device as at least one processor of the processing resource or separate from but accessible to at least one of the processors of the processing resource.

In some examples, the instructions can be part of an installation package that, when installed, can be executed by the processing resource to implement the engines of system 100. In such examples, the machine-readable storage medium may be a portable medium, such as a CD, DVD, or flash drive, or a memory maintained by a server from which the installation package can be downloaded and installed. In other examples, the instructions may be part of an application or applications already installed on a computing device including the processing resource. In such examples, the machine-readable storage medium may include memory such as a hard drive, solid state drive, or the like.

In the example of FIG. 1, a group engine 122 may group a second plurality of the chunks of plurality 145 into a second compression region 162 for chunk container 150 based on supplemental order information 142. In some examples, the second plurality of the chunks may include chunks of the first plurality that are from different first compression regions of chunk container 150 (e.g., chunks from compression regions 152 and 156). As used herein, “supplemental order information” is information, additional to the order of a plurality of chunks in an associated chunk container and stored in or separate from the associated chunk container, which specifies proximity relationship(s) for various chunks of the plurality in any of at least one ordered collection of chunks different than and at least partially stored in the associated chunk container. An ordered collection of chunks different than a chunk container may be a backup stream, for example. Additionally, as used herein, any ordered collection of chunks is at least partially stored in a chunk container if the chunk container stores at least one chunk of the ordered collection. In such examples, the supplemental order information may specify proximity relationship(s) for various chunks in any of at least one backup stream. In some examples, supplemental order information 142 may specify various proximity relationships of chunks in various different backup streams. By grouping chunks into a compression region based on such supplemental order information, engine 122 may group into a compression region chunks likely to be retrieved together, as described above.

In the example of FIG. 1, supplemental order information 142 may be stored in chunk container 150. In other examples, supplemental order information 142 may be stored separate from chunk container 150. In examples described herein, supplemental order information may be stored in any suitable form or format and may indicate proximity relationship(s) in any suitable manner. For example, supplemental order information 142 may include pointer(s) indicating proximity relationship(s) among the chunks of chunk container 150. In other examples, supplemental order information 142 may include backup manifest(s) separate from chunk container 150 that indicate the order of chunks in respective backup stream(s), or the ordering information included in such backup manifest(s):

In the example of FIG. 1, supplemental order information 142 may specify, for at least one pair of the chunks of first plurality 145, a proximity relationship for the pair of chunks in an ordered collection of chunks different than and at least partially stored in the chunk container. For example, supplemental order information 142 may specify that chunks 12 and 13′ are proximate (e.g., adjacent) to one another in a backup stream representing a sequence of data input to system 100. In such examples, engine 122 may group chunks 11, 12, 13′, and 13 into a second compression region 162 for chunk container 150 based on supplemental order information 142 indicating that chunks 12 and 13′ are proximate in the backup stream. In such examples, engine 122 may group into second compression region 162 chunks from different first compression regions (e.g.:, from compression regions 152 and 156). In some examples, engine 122 may replace compression regions of chunk container 150, including first compression region 152, with new or different compression regions, including second compression region 162. In some examples, engine 122 may also group other chunks of first plurality 145 into new or different compression region(s), which engine 122 may use, in combination with compression region 162, to replace at least one of compression regions 152, 154 and 156. In some examples, at least one of the compression regions of chunk container 150 may remain unchanged,

Compression engine 124 may compress the chunks of second compression region 162 relative to each other and independent of any other compression region of chunk container 150. Engine 124 may compress the chunks of second compression region 162 with any suitable compression functionality. For example, engine 124 may utilize any suitable general purposes compression functionality. In some examples, engine 124 may compress the chunks of second compression region 162 utilizing or based on any compression algorithm of the Lempel-Ziv family of compression algorithms. In some examples, engine 124 may compress away duplicate data within a given compression region. For example, if a piece of data is repeated within the compression region, a given occurrence of the piece data may remain, while each other occurrence of the piece of data may be replaced with a pointer (or other reference) to the given occurrence.

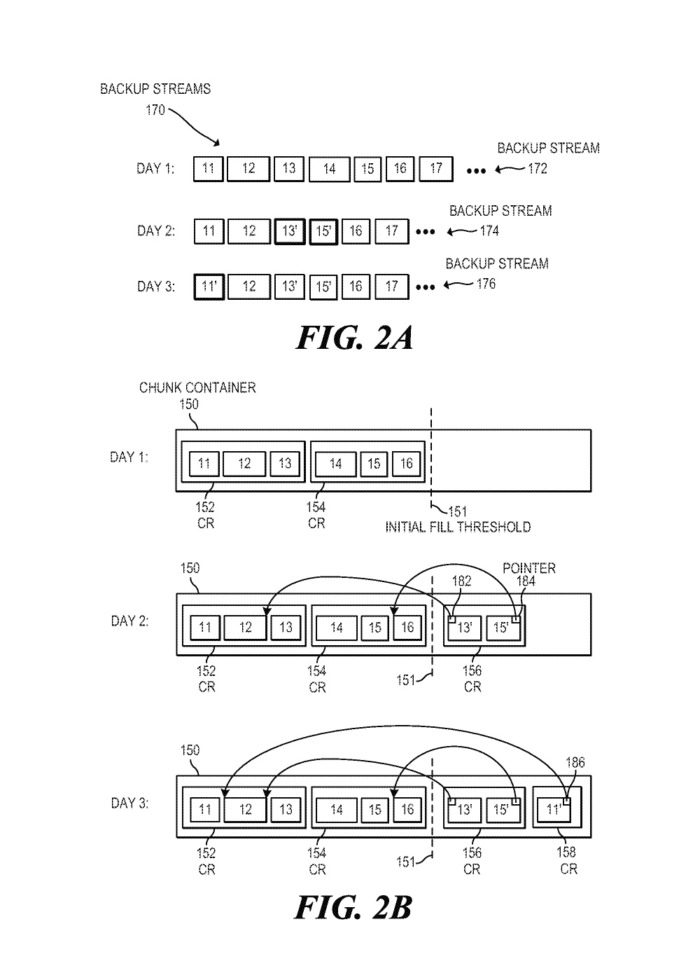

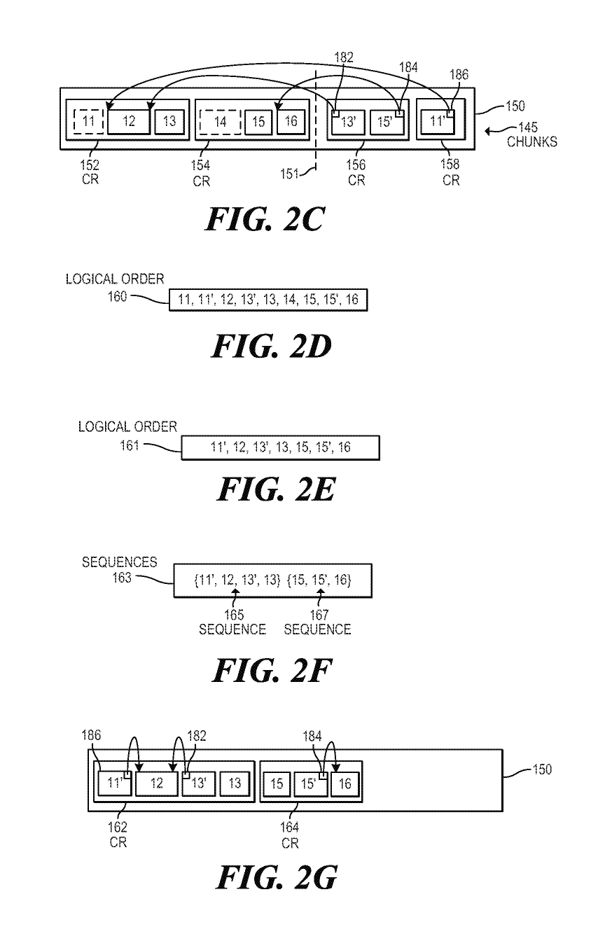

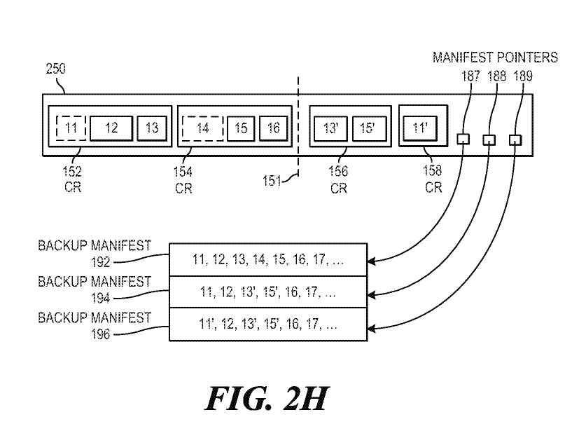

In some examples, system 100 may implement at least a portion of a data backup system. As used here, a “backup system” (or “data backup system”) may be a data storage system that performs deduplication and compression on data it stores. For example, engines 122 and 124 may be part of a larger set of engines implementing functionality of a backup system, and memory 140 may implement at least a portion of storage of the backup system. Features of system 100 are described below in relation to FIGS. 2A-2H in the context of an example in which system 100 implements at least a portion of a backup system. Although in some examples a backup system may store backup data, as described herein, in other examples a backup system may store other types of data, such as data for primary storage, archival records, or the like.

FIG. 2A is a diagram of example backup streams 170 of a backup system at least partially implemented by system 100 of FIG. 1. FIG. 2B is a diagram of an example chunk container 150 storing chunks of backup streams 170 of FIG. 2A. In the example of FIG. 2A, the backup system may receive different sequences of backup data each day, with each sequence representing backup data provided to the backup system on each of the days. In such examples, the backup system may divide each of the sequences into chunks, as described above, to form backup streams 170. In some examples, the backup data for a given day may include copies of all the files (or other data) on a system being backed up as of that day. In other examples, the backup data for a given day may include copies of the files (or other data) that have changed since the last backup. Although backup streams are associated with respective days in the example illustrated in FIG. 2A, in other examples backup streams may be associated with different time frames, or the like.

For example, the backup system may divide a sequence of data representing backup data for a first day (e.g., “day 1”) into a backup stream 172 including at least chunks 11-17. The backup system may divide a sequence of data for a second day (e.g., “day 2”) into a backup stream 174 and may divide a sequence of data for a third day (e.g., “day 3”) into a backup stream 176. As shown in FIG. 2A, in backup stream 174 for day 2, chunks 13′ and 15′ (illustrated in bold) have replaced chunks 13-15 of day 1. For example, the data of 13-15 may have been modified (and shortened) such that the modified data is included in chunks 13′ and 15′ in backup stream 174 and chunk 14 is no longer present. Also, in backup stream 176 of day 3, chunk 11′ (illustrated in bold) has replaced chunk 11 of day 2. For example, the data of chunk 11 may have been modified between days 2 and 3. As shown in FIG. 2A, the respective sizes of the chunks of backup streams 170 may vary.

As shown in FIG. 2B, the backup system may store certain chunks of backup streams 170 in a chunk container 150. FIG. 2B shows the state of chunk container 150 at the end of days 1, 2, and 3, respectively, in accordance with an example described herein. In the example of FIGS. 1-2G, the backup system may create a new, empty chunk container 150 to store chunks of backup stream 172 of day 1, and may add chunks of backup stream 172 to chunk container 150 until an initial fill threshold 151 is reached. In such examples, chunk container 150 may have a maximum size. In examples described herein, the maximum size of a chunk container may represent a total amount of compressed data or a total amount of uncompressed data that may be stored in a chunk container. The initial fill threshold 151 may represent a size less than the maximum size. The initial fill threshold may be represented in any suitable form or format. For example, initial fill threshold 151 may be represented as a percentage of the maximum size (e.g., 50%, etc.), as a size value less than the maximum size, or the like.

In the example of FIGS. 2A-2B, the backup system may add chunks of backup stream 172 to chunk container 150 until initial fill threshold 151 is reached. For example, the backup system may add chunks 11-16 to chunk container 150 and cease adding to chunk container 150 upon determining that threshold 151 has been reached or that adding another chunk (e,g., chunk 17) would exceed threshold 151. Once chunk container 150 has been filled in this manner, additional chunks of backup stream 172 (e.g., chunk 17) may be placed in additional new chunk containers (not shown). Also, once a chunk container has initially been filled with chunks as described above, additional chunks may in some examples be added to it when they have a proximity relationship with existing chunks in that chunk container (e.g., chunks 13′ and 15′ of day 2, as described below). In the example of FIGS. 2A-2B, there are no such chunks in the rest of backup stream 172. In some examples, the addition of chunks to a chunk container based on proximity relationships may not be limited by the initial fill threshold that applies to the initial fill process.

The backup system may also group chunks 11-13 into a compression region 152, and group chunks 14-16 into a compression region 154. The backup system may further compress the chunks of compression region 152 relative to one another, and may compress the chunks of compression region 154 relative to one another. The compression may be performed as described above in relation to engine 124. In examples described herein, for each compression region, chunks of the compression region may be compressed relative to one another and independent of any other compression region.

In some examples, the backup system may group chunks of a chunk container into compression regions after the initial filling of container 150 has ceased (e.g., after reaching threshold 151). In such examples, the compression may be performed after the chunks are grouped into the compression regions. In other examples, the backup system may add chunks to compression regions as they are added to the chunk container. In such examples, chunks may be added to an open compression region until the compression region is full (e,g., based on an upper threshold for compression region size), after which a new compression region is started for additional chunks. This process may continue until the threshold 151 is reached. In such examples, the compression may be performed on the added chunks as they are added to a compression region, or may be performed for each compression region after threshold 151 is reached. In examples described herein, an upper threshold for compression region size may be indicated in any suitable manner. For example, an upper threshold for compression region size may be specified as a total amount of compressed data, a total amount of uncompressed data, a number of chunks, or the like, or a combination thereof.

Based on backup stream 174 for day 2, the backup system may determine to add new chunks 13′ and 15′ to chunk container(s). Previously stored chunks 11, 12, 16, and 17 are not added again to chunk container(s) due to the deduplication functionalities of the backup system. The backup system may add chunks 13′ and 15′ to chunk container 150 since they are proximate to chunks 12 and 16, respectively, in backup stream 174, chunks 12 and 16 are located in chunk container 150, and sufficient space is available in chunk container 150. In such examples, 13′ and 15′ may be grouped into a new compression region 156 of chunk container 150. In some examples, chunks added to a chunk container after the initial fill may be appended to the chunk container or otherwise added to the chunk container in a manner that does not involve reading or writing the existing chunks in the chunk container. In such examples, adding new chunks to a chunk container in this manner may, at the time of the addition of the new chunks, prevent the addition of the new chunks to compression regions including chunks previously stored in the chunk container.

In addition, the backup system may store supplemental order information 142 specifying proximity relationships for 13′ and 15′. In some examples, supplemental order information 142 may include at least one neighbor pointer. As used herein, a “neighbor pointer” may be a pointer associated with a first chunk of a chunk container indicating a second chunk of the chunk container proximate to the first chunk in an ordered collection of chunks different than and at least partially stored in the chunk container, such as a backup stream. In some examples, a neighbor pointer associated with a first chunk of a chunk container may indicate a second chunk of the chunk container that is adjacent to the first chunk in a backup stream. In some examples, a neighbor pointer may indicate the relative order of the first and second chunks in a backup stream (or other ordered collection of chunks) in any suitable manner. For purposes of description and illustration, this order relationship may be described herein in terms of the second chunk being the “left” or “right” neighbor of the first chunk. In such examples, a second chunk referred to as a “left” neighbor of a first chunk may indicate a second chunk that precedes the first chunk in a backup stream, and a second chunk referred to as a “right” neighbor of a first chunk may indicate a second chunk that follows the first chunk in the backup stream,

In the example of FIG. 2B, the backup system may store in chunk container 150 a neighbor pointer 182 associated with chunk 13′ and indicating that chunk 12 is adjacent to (e.g., the left neighbor of) chunk 13′ in backup stream 174, at least a portion of which is stored in chunk container 150. In addition, the backup system may store in chunk container 150 a neighbor pointer 184 associated with chunk 15′ and indicating that chunk 16 is adjacent to (i.e., the right neighbor of) chunk 15′ in backup stream 174. In such examples, neighbor pointers 182 and 184 may he included in supplemental order information 142 of FIG. 1. Although, for purposes of illustration, each neighbor pointer is illustrated as included in a chunk associated with the pointer, the pointers may be stored within chunk container 150 but separate from the chunks of chunk container 150.

Based on backup stream 176 for day 3, the backup system may determine to add new chunk 11′ to a chunk container. Previously seen chunks 12, 16, and 17 are not added again to chunk container(s) due to the deduplication functionalities of the backup system. The backup system may add chunk 11′ to chunk container 150 since chunk 11′ is proximate to chunk 12 in backup stream 176, chunk 12 is stored in chunk container 150, and sufficient space is available in chunk container 150. In such examples, chunk 11′ may be placed in its own compression region 158 of chunk container 150. In addition, the backup system may store a neighbor pointer 136 in chunk container 150 indicating that chunk 12 is the right neighbor of chunk 11′ in backup stream 176. Neighbor pointer 186 may be included in supplemental order information 142 of FIG. 1. In the example of FIGS. 1-2G, chunk container 150 may be considered full after adding chunk 11′.

Over time, an entity utilizing the backup system may delete earlier backup streams (e.g., to save space). For example, an entity may be allocated a limited amount of storage space and thus there may a limit to the number (total size, etc.) of backup streams the entity is able to store at one time. In such circumstances, an entity may maintain a limited number of days of backup data For example, 30 days of backup data may be maintained. In such examples, each time a sequence of a backup data for a new day is received, a backup stream of data received 30 days earlier may be deleted. The backup system may perform this deletion automatically in accordance with a policy set in the backup system, for example.

In such examples, chunks that are no longer part of any non-deleted backup stream may be considered garbage available for removal from the backup system. In the example of FIGS. 2A-2B, if backup streams may be deleted after 30 days, then chunk 14 may be considered garbage on day 31, and chunk 11 may be considered garbage on day 33. In some examples, the removal of chunk(s) considered garbage (a process referred to herein as “garbage collection”) may not be performed by the backup system immediately after deleting a backup stream or determining that certain chunk(s) are garbage. Rather, a backup system may wait until a relatively large amount of garbage is ready for removal before performing garbage collection (e.g., for efficiency). As such, the backup system may mark certain chunks stored by the system as garbage for eventual deletion (e.g., at the time of garbage collection). In some examples, upon determining that an amount of available space in a storage unit is below a threshold, the backup system may determine to perform garbage collection on that storage unit. In some examples, the storage unit may be a chunk container, such as chunk container 150. In some examples, in addition to performing garbage collection on a chunk container, the backup system may also rearrange the chunks of that chunk container to group them into different compression region(s). The resulting compression regions may include chunks that are likely to be retrieved together. As noted above, the storage unit may be a chunk container. In other examples, the storage unit may be the total storage space allocated for a particular user or other entity (including at least one chunk container), the total storage space in the backup system as a whole (including at least one chunk container), or the like.

FIGS. 2C-2G illustrate an example of grouping chunks into a compression region based on supplemental order information with system 100 of FIG. 1, FIG. 2C illustrates the filled chunk container 150 of FIG. 2B with chunks 11 and 14 considered garbage (as illustrated with dotted borders). In such examples, chunk container 150 of FIG. 2C may be stored in memory 140 of FIG. 1, and the chunks of first plurality 145 may include chunks 11-16, 13′, 15′, and 11′.

In such examples, in response to determining that there is insufficient available space in a given storage unit, system 100 may begin a process to group chunks into a compression region based on supplemental order information. For example, in response to a determination that there is insufficient available space in a given storage unit comprising chunk container 150, group engine 122 may determine a logical order 160 for the chunks of first plurality 145 based on supplemental order information 142, as illustrated in FIG. 2D. Logical order 160 may be a total or partial ordering of the chunks of first plurality 145. Engine 122 may determine logical order 160 based on pointers 182, 184, and 186 of supplemental order information 142. For example, starting with the order of the chunks of first plurality 145 in chunk container 150, and based on pointers 182, 184, and 186, engine 122 may determine that chunk 11′ immediately precedes chunk 12, chunk 13′ immediately follows chunk 12, and chunk 15′ immediately precedes chunk 16. In such examples, engine 122 may determine the following logical order 160 for the chunks of chunk container 150: 11 11′, 12, 13′, 13, 14, 15, 15′, and 16. Engine 122 may do this by modifying the existing order of the chunks added when the container was initially filled (i.e., 11, 12, 13, 14, 15, and 16) using the supplemental order information Engine 122 may further remove from logical order 160 the chunk(s) marked as garbage or the chunk(s) that it determines are garbage (i.e., chunks 11 and 14), to generate logical order 161 illustrated in FIG. 2E (i.e., 11′, 12, 13′, 13, 15, 15′, and 16). In some examples, chunks may he marked as garbage when they are no longer used by any backup stream. In other examples, a determination of whether a chunk is garbage may be made at garbage collection time.

Engine 122 may then select a sequence of chunks of logical order 161 to be grouped into second compression region 162 for chunk container 150. For example, after determining logical order 161, engine 122 may determine one or more sequences of the chunks indicated in logical order 161. In such examples, engine 122 may determine the sequences such that all the chunks of a given sequence may be stored in a single compression region. For example, engine 122 does not determine any sequence that is too long for all of the chunks in that sequence to be included in the same compression region. Engine 122 may also determine the sequences such that the chunks of each sequence (with the exception of the last) would form a compression region satisfying a lower threshold for compression region size. Engine 122 may select one of the determined sequence(s) of chunks specified in logical order 161 to group into a second compression region 162 for chunk container 150.

For example, as illustrated in FIG. 2F, engine 122 may divide logical order 161 into a plurality 163 of sequences, including sequences 165 and 167. In such examples, sequence 165 may include the first four chunks indicated in logical order 161, and sequence 167 may include the last three chunks indicated in logical order 161. In such examples, engine 122 may determine sequences 165 and 167 such that the chunks of any given sequence may be stored in a single compression region without exceeding an upper threshold for compression region size, as described above. In such examples, engine 122 may select sequence 165 as a plurality of chunks to be grouped into second compression region 162 for chunk container 150.

In such examples, engine 122 may group the chunks specified in sequence 165 (i.e., chunks 11′, 12, 13′, and 13) into a second compression region 162 for chunk container 150, as illustrated in FIG. 2G. Engine 122 may also group the chunks specified in sequence 167 (i.e., chunks 15, 15′, and 16) into another compression region 164 for chunk container 150, as illustrated in FIG. 2G. In such examples, engine 122 may replace compression regions 152, 154, 156, and 158 of chunk container 150 (see FIG. 2C) with compression regions 162 and 164 (see FI(3. 2G). By performing this replacement, chunks 11 and 14 (which were considered garbage) are deleted from chunk container 150, providing space in chunk container 150 for adding new chunks in the future. In some examples, chunk container 150 may retain at least some of supplemental order information 142 when previous compression regions are replaced with compression regions 162 and 164. For example, chunk container 150 may retain at least pointers 182, 184, and 186, as illustrated in FIG. 2G. Additionally, in some examples, for each of compression regions 162 and 164, engine 124 may compress the chunks of the compression region relative to each other and independent of any other compression region of chunk container 150.

As noted above in relation to FIG. 1, supplemental order information 142 may he stored separate from chunk container 150. For example, supplemental order information 142 may include ordering information of at least one backup manifest. In such examples, chunk container 150 may contain pointer(s) to the backup manifest(s) (referred to herein as “manifest pointer(s)”). FIG. 2H is a block diagram of a chunk container 250 including manifest pointers 187-189. In such examples, manifest pointers 187-189 are pointers to respective backup manifests 192, 194, and 196 stored separate from chunk container 250. In examples described herein, a “backup manifest” is information indicating an order of chunks in a backup stream. For example, each of backup manifests 192, 194, and 196 indicates the order of chunks in a respective one of backup streams of 172, 174, and 176 of FIG. 2A. In such examples, supplemental order information 142 may include at least a portion of the order of chunks indicated in each of backup manifests 192-196. Although FIG. 2H shows manifest pointers pointing to backup manifests for entire backup streams, in some examples manifest pointers may point to pieces of backup manifests, each indicating an order of chunks for a given portion of a backup stream. In other examples, manifest pointers may point to locations inside of backup marffests. For example, a manifest pointer may indicate a region of a backup stream including chunks stored in the associated chunk container.

In examples described herein, system 100 may determine a new grouping of chunks into compression region(s) for a chunk container prior to rearranging the chunks themselves. In such examples, system 100 may logically determine a new arrangement of chunks for a chunk container and subsequently rearrange chunks of the chunk container into the determined new arrangement. For example, in the example of FIGS. 2C-2G, engine 122 may perform the functionalities illustrated in FIGS, 2D-2F logically, without rearranging the chunks themselves. In such examples, the ordering and grouping of chunks described in relation to FIGS. 2D-2F may be performed with identifiers (or the like) for the chunks, rather than the chunks themselves. In some examples, after determining sequences 163, system 100 may then rearrange chunks of chunk container 150 from the arrangement of FIG. 20 to the arrangement of FIG. 2G. Additionally, compression regions 152, 154, 156, and 158 of FIG. 2C may each be compressed, as described above, prior to the rearranging process described above in relation to FIGS. 2B-2G. In such examples, compression engine 124 may decompress some or all of the compression regions prior to rearranging the chunks to the new arrangement of FIG. 2G. In some examples, compression engine 124 may omit the decompression of any compression region remaining the same in the new arrangement or whose chunks are considered garbage.

Referring again to FIG. 1, in some examples, engine 122 may group a second plurality of the chunks of the plurality 145 of chunk container 150 into a second compression region 162 for chunk container 150 based on supplemental order information 142 and based on similarity among the data of the chunks of plurality 145. In some examples, chunks may be considered similar if they have in common at least one of a prefix and a suffix. For example, a group of chunks may be considered similar if they all have the same prefix, if they all have the same suffix, or both. In examples described herein, a “prefix” of a chunk of data may be a continuous sequence of the data starting at the beginning of the data and comprising less than all of the data of the chunk. In examples described herein, a “suffix” of a chunk of data may be a continuous sequence of the data comprising less than all of the data of the chunk and ending at the end of the data of a chunk. In some examples, engine 122 may determine similarity of chunks based on whether they have in common at least one of a fixed-length prefix and a fixed-length suffix. In such examples, for each chunk, the prefix of the chunk may be the first 50 bytes of the data of the chunk, and the suffix of the chunk may be the last 50 bytes of the data of the chunk. In other examples, any other suitable value may be used for the length of a prefix or suffix (e.g., 100 bytes, etc.). In some examples, engine 122 may determine similarity of chunks based on hashes of their respective prefixes and suffixes, as described in more detail below.

In some examples, chunks having prefixes or suffixes in common may occur frequently in successive backup streams, as modifications to data frequently may not coincide exactly with chunk boundaries. For example, referring to FIG. 2A, a modification to the data of chunks 13, 14, and 15 may start among the data of chunk 13 and extend into the data of chunk 15. If the modification does not start at the beginning of the data of chunk 13 and end at the end of the data of chunk 15, then chunk 13′ may share a prefix with chunk 13 (i.e., the unmodified portion of chunk 13) and chunk 15′ may share a suffix with chunk 15 (i.e., the unmodified portion of chunk 15). Additionally, grouping similar chunks into compression regions may improve compression, as repeated prefixes or suffixes in a compression region may be substantially compressed away. In addition, determining similarity based on prefixes and suffixes may be a relatively efficient way to identify similar, non-identical chunks of backup streams.

In some examples, engine 122 may utilize similarity among the data of the chunks to break ties while forming logical order 160 when supplemental order information indicates the same position for two different chunks. For example, referring to FIGS. 2C-2D, in an example in which chunk container 150 includes chunks 13′, 13″, and 13′″, and supplemental order information 142 indicates that each of these chunks is he right neighbor of chunk 12, there may not be sufficient space to include all three chunks 13′, 13″, and 13′″ in the same compression region as chunk 12. In such examples, engine 122 may determine which of chunks 13′-13″ to place to the right of chunk 12 in logical order 160, based on similarity among the data of the chunks of chunk container 150. For example, if any of chunks 13′, 13″, and 13′ have data in common with chunk 12, those chunk(s) may be placed closest to chunk 12 in logical order 160 rather than another of the chunks that does not have data in common with chunk 12, such that similar chunks may be placed in the same compression region. Any of chunks 13′-13′″ determined not to have data in common with chunk 12 may be placed further away from chunk 12 in logical order 160. As described above, placing similar chunks in the same compression region may improve compression,

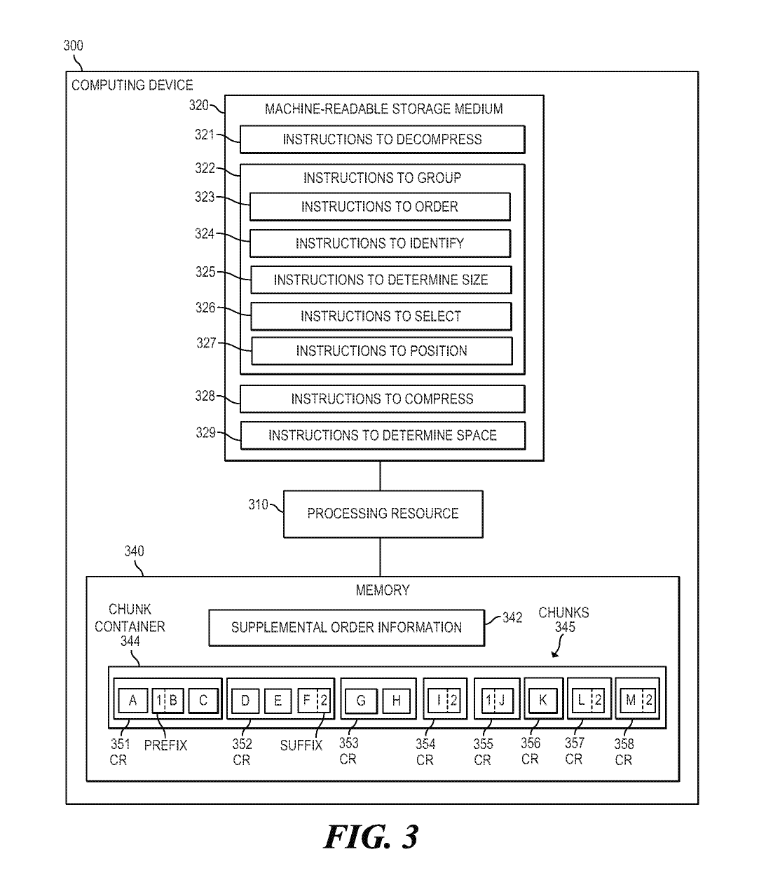

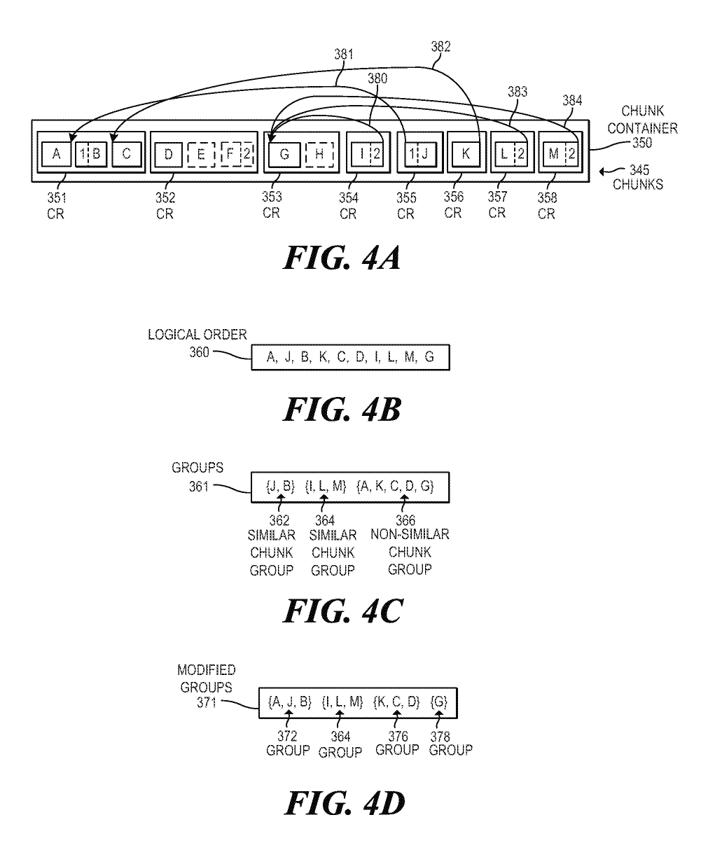

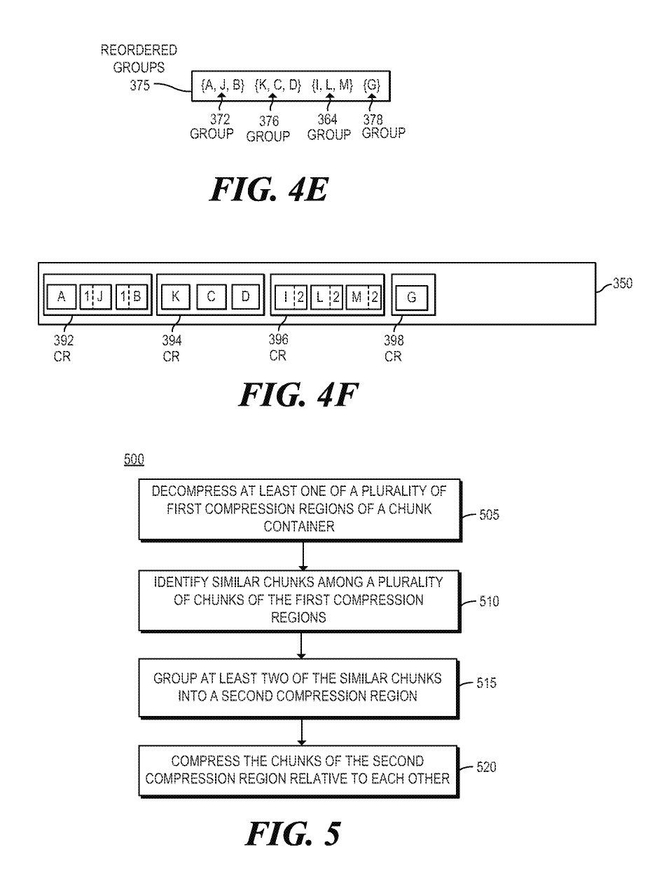

In other examples, engine 122 may group a second plurality of the chunks of first plurality 145 of chunk container 150 into a second compression region 162 for chunk container 150 based on supplemental order information 142 and similarity among the data of the chunks of plurality 145 as described below in relation to FIGS. 3-4F. In such examples, engine 122 may identify similar chunks among the first plurality 145 for which the data of each of the similar chunks all have in common at least one of a prefix and a suffix. In such examples, engine 122 may group at least two of the similar chunks into the second compression region. In other examples, engine 122 may identify as similar chunks a group of the first plurality 145 of chunks for which each pair of the chunks have in common at least one of a prefix, a suffix, or both,

In other examples, engine 122 may group a second plurality of the chunks of first plurality 145 of chunk container 150 into a second compression region 162 for chunk container 150 based on supplemental order information 142 and similarity among the data of the chunks of plurality 145 in any other suitable manner. For example, engine 122 may consider similarity between chunks to be a force between the chunks (e.g., having a strength proportional to the degree of similarity) and may consider a proximity relationship between chunks to be another force between the chunks (e,g., having a strength based on the proximity relationship). In such examples, engine 122 may determine a logical order for the chunks of a chunk container based on the forces (e.g., by solving for a minimal energy configuration for the chunks along a one-dimensional line based on the forces). In such examples, engine 122 may further determine at least one second compression region based on the logical order, as described above in relation to FIGS. 2D-2G. Although examples are described herein in the context of a data backup system, examples described herein may he applied in other contexts as well. In some examples, functionalities described herein in relation to FIGS. 1-2H may be provided in combination with functionalities described herein in relation to any of FIGS. 3-5.

FIG. 3 is a block diagram of an example computing device 300 to group chunks into a compression region based on similarity among the data of the chunks and based on supplemental order information. In the example of FIG. 3, computing device 300 includes a processing resource 310 and a machine-readable storage medium 320 comprising (e.g., encoded with) instructions 321-328. In some examples, storage medium 320 may include additional instructions. In other examples, instructions 321-328, and any other instructions described herein in relation to storage medium 320, may be stored on a machine-readable storage medium remote from but accessible to computing device 300 and processing resource 310. Processing resource 310 may fetch, decode, and execute instructions stored on storage medium 320 to implement the functionalities described below. In other examples, the functionalities of any of the instructions of storage medium 320 may be implemented in the form of electronic circuitry, in the form of executable instructions encoded on a machine-readable storage medium, or a combination thereof. Machine-readable storage medium 320 may be a non-transitory machine-readable storage medium. In the example of FIG. 3, instructions 322 may comprise instructions 323-327,

In the example of FIG. 3, memory 340 may store a chunk container 344 comprising first compression regions 351-358. First compression regions 351-358 may comprise a first plurality 345 of chunks of data, and may each be compressed. In the example of FIG. 3, the chunks of first plurality 345 may include chunks A-M. In some examples, chunks A-M may be different sizes. In other examples, chunk container 344 may include a different number of compression regions, a different number of chunks, a different grouping of chunks into compression regions, or a combination thereof. In the example of FIG. 3, the data of chunk B includes a prefix 1, as does the data of chunk J. In addition, the respective data of chunks F, L, and M each include the same suffix 2. Memory 340 may store supplemental order information 342 for the chunks of first plurality 345. In the example of FIG. 3, supplemental order information 342 is stored separate from chunk container 344. In other examples, supplemental order information 342 may be stored in chunk container 344,

In the example of FIG. 3, instructions 321 may decompress at least one of first compression regions 351-358, and instructions 322 may group a second plurality of the chunks of first plurality 345 into a second compression region for chunk container 344 based on similarity among the data of the chunks of the first plurality and based on supplemental order information 342. In some examples, similarity among data of the chunks may include having a prefix or suffix in common, as described above. The second compression region (alone or in combination with other compression region(s)) may replace at least one of first compression regions 351-358 of chunk container 344. In some examples, instructions 321 may decompress each of compression regions 351-358. In other examples, instructions 321 may decompress less than all of compression regions 351-358, as described above. For example, instructions 321 may determine which of compression regions 351-358 are not being altered by instructions 322 or whose chunks are all considered garbage, and may omit the decompression of those compression regions.

Additionally, instructions 328 may compress the second plurality of the chunks of the second compression region relative to each other. Instructions 328 may compress chunks with any suitable compression functionality. For examples, instructions 328 may compress chunks with any suitable compression functionality described above in relation to engine 124 of FIG. 1.

In some examples, computing device 300 may implement at least a portion of a data backup system. For example, instructions 321-328 may be part of a larger set of instructions implementing functionalities of a backup system, and memory 340 may implement at least a portion of the storage of the backup system. Features of computing device 300 are described below in relation to FIGS. 4A-4F in the context of an example in which computing device 300 implements at least a portion of a backup system,

FIGS. 4A-4F illustrate an example of grouping chunks into a compression region based on similarity and supplemental order information with computing device 300 of FIG. 3. FIG. 4A illustrates an example chunk container 350 that is the same as chunk container 344 of FIG. 3, except that supplemental order information 342 is stored in chunk container 350 rather than separate from it. In the example of FIGS. 4A-4F, the backup system may receive different sequences of backup data each day, which may be divided into chunks to form backup streams, as described above in relation to FIG. 2A. In addition, the chunks of the backup streams may be stored in chunk containers as described above in relation to FIGS. 2A and 2B. For example, a backup stream for a first day may include chunks A-H, which may be added to chunk container 350, as shown in FIG. 4A. Chunk container 350 may be stored in memory 340 of computing device 300. The backup system may store chunks A-C in compression region 351, chunks D-F in compression region 352, and chunks G and H in compression region 353. In some examples, chunks I-M may be included in respective backup streams for different days, and may each be proximate to chunks already stored in chunk container 344 (e.g., chunks A-G) in their respective backup streams. In such examples, each of chunks I-M may be added to chunk container 344 in its own compression region since they were each added (i.e., appended) to chunk container 344 at different times. For example, as shown in FIG. 4A, chunks I-M may be stored in compression regions 354-358, respectively.

In such examples, the backup system may store supplemental order information 342 specifying proximity relationships for chunks I-M in chunk container 350. Supplemental order information 342 may specify, for at least one pair of the chunks of first plurality 345, a proximity relationship for the pair of chunks in an ordered collection of chunks different than and at least partially stored in the chunk container. In the example of FIGS. 4A-4F, supplemental order information 342 may include neighbor pointers 380-384 associated with chunks I-M, respectively. Pointer 380 associated with chunk I may indicate that chunk G is adjacent to (e.g., the right neighbor of) chunk I in a backup stream, pointer 381 associated with chunk J may indicate that chunk A is adjacent to (e.g., the left neighbor of) chunk J in a backup stream, and pointer 382 associated with chunk K may indicate that chunk C is adjacent to (e.g., the right neighbor of) chunk K in a backup stream. Additionally, pointer 383 associated with chunk L may indicate that chunk G is adjacent to (e.g., the right neighbor of) chunk L in a backup stream, and, pointer 384 associated with chunk M may indicate that chunk G is adjacent to (e,g., the right neighbor of) chunk M in a backup stream. Pointers may be stored within chunk container 350, but separate from the chunks of chunk container 350.

As described above, over time the backup system may mark certain chunks stored by the backup system as garbage for eventual deletion (e.g., at the time of garbage collection). In the example of FIGS. 4A-4F, chunks E, F, and H may be marked as garbage (illustrated with dotted outlines). In some examples, instructions 329 may determine that an amount of available space in a storage unit comprising chunk container 350 is below a threshold, as described above. In response, instructions 322 may determine to perform garbage collection. In some examples, in addition to performing garbage collection, instructions 322 may group chunks of chunk container 350 into compression regions based on similarity among the data of the chunks of the first plurality 345 and based on supplemental order information 342.

For example, when chunk container 350 is in the state illustrated in FIG. 4A, instructions 322 may determine that an amount of available space in a storage unit comprising chunk container 350 is below a threshold (e.g., chunk container 350 has no free space left). In response, instructions 322 may begin a process of grouping chunks into compression region(s) based on similarity and supplemental order information as illustrated in FIGS. 4A-4F. For example, in response to the determination, instructions 323 may determine a logical order 360 (illustrated in FIG, 4B) for the chunks of first plurality 345, based on supplemental order information 342. Logical order 360 may be a total or partial ordering of the chunks of first plurality 345. Instructions 323 may determine logical order 360 based on pointers 380-384 of supplemental order information 342. For example, instructions 322 may determine that, for logical order 360, chunk J immediately follows chunk A (see pointer 381), chunk K immediately precedes chunk C (see pointer 382), and each of chunks I, L, and M are to the left of chunk G (see pointers 380, 383, and 384). The relative order of chunks I, L, and M to the left of chunk G may be determined in any suitable manner. Instructions 323 may also exclude (or remove), from logical order 360, chunks E, F, and H, which are marked as garbage.

As illustrated in FIG. 4C, instructions 324 may identify a plurality 361 of groups of the chunks identified in logical order 360. For example, instructions 324 may identify at least one group of similar chunks, among the chunks of first plurality 345, for which the data of the chunks of the group all have in common at least one of a prefix and a suffix. In such examples, the group(s) of similar chunks may be identified among the chunks not marked as garbage, such as the chunks of logical order 360. In addition, instructions 322 may include at least two of the similar chunks in a second compression region for chunk container 350, as described below. In the example of FIGS. 4A-4F, instructions 324 may identify the chunks that have prefix 1 in common (i.e., chunks J and B) as a first group 362 of similar chunks. Instructions 324 may also identify the chunks that have suffix 2 in common (i.e., chunks L, and M) as a second group 364 of similar chunks. In such examples, instructions 324 may also determine a third group 366 of non-similar chunks A, K, C, D, and G that do not share a prefix or a suffix with any other chunk of logical order 360. In other examples, instructions 324 may identify as similar chunks a group of the chunks of first plurality 145 for which each pair of the chunks have in common at least one of a prefix, a suffix, or both. In some examples, the ordering of the chunks within the groups may be inherited from the logical order 360. Each chunk of chunk container 350 not considered garbage may be contained in exactly one group of groups 361.

In some examples, instructions 324 may determine similarity of chunks of a chunk container based on hashes (e.g., hash values) of prefixes and suffixes of the data of each of the chunks. For example, instructions 324 may compute, for at least some of the chunks of first plurality 345, a first hash of a prefix of the data of the chunk and a second hash of a suffix of the data of the chunk. For example, instructions 324 may compute the hashes for each of the chunks of chunk container 350, or for those not marked as garbage. As described above, in examples described herein, prefixes and suffixes of chunks of data may have fixed lengths. For example, instructions 324 may compute, for at least some of the chunks of first plurality 345, a first hash of a prefix (e.g., the first 50 bytes) of the data of the chunk and a second hash of a suffix (e.g., the last 50 bytes) of the data of the chunk. In other examples, the fixed length may be any other suitable length (e.g., 100 bytes, etc.).

Instructions 324 may determine that a pair of chunks of the first plurality 345 have a prefix in common when the first hashes for the pair of chunks are equivalent. Instructions 324 may further determine that a pair of chunks of the first plurality 345 have a suffix in common when the second hashes for the pair of chunks are equivalent. In some examples, hashes of each (non-garbage) chunk may be computed as part of the process of grouping the chunks, triggered in response to determining that the amount of available space in a storage unit comprising chunk container 350 is below a threshold. In other examples, instructions 324 may compute and store the hashes (e,g., in memory 340) prior to the grouping process. In such examples, instructions 324 may determine whether chunks are similar based on the previously stored hashes.

In the example of FIGS. 4A-4F, instructions 325 may determine that a size of the group 362 of similar chunks does not meet a lower threshold for compression region size. A size of a group of chunks may be based on the number of chunks, the sum of the sizes of their uncompressed data, or the sum of their sizes when compressed relative to one another and independent of any other compression region. For example, instructions 325 may determine that the lower threshold for compression region size would not be met by a compression region including no more than the chunks identified in group 362 (e.g., chunks J and B). In response, instructions 326 may select one or more of the non-similar chunks group 366 to add to group 362. Instructions 326 may select one of the non-similar chunks based on a proximity relationship, specified in supplemental order information 342, between the selected chunk and one of chunks of group 362 of similar chunks. Instructions 326 may further group the selected chunk and the similar chunks of group 362 into a second compression region, as described below.

For example, in response to determining that the chunks of group 362 would not meet the lower threshold for compression region size, instructions 326 may determine that pointer 381 of a supplemental order information 342 indicates a proximity relationship between chunks J and A, in response, instructions 326 may move an identifier for chunk A from group 366 to group 362 to create a modified group 372 specifying chunks A, J, and B (i.e., the selected chunk and the chunks of group 362), in examples described herein, instructions 326 may move chunks from group 366 to respective group(s) of similar chunks until the chunks specified by such groups would each meet the lower threshold for compression region size, or until group 366 of non-similar chunks is empty,

Additionally, after moving chunk(s) (if any) from group 366 to group(s) of similar chunks, instructions 325 may further determine whether the chunks of group 366 would exceed an upper threshold for compression region size (e.g., a maximum compression region size). In response to a determination that the chunks of group 366 would exceed the upper threshold, instructions may split group 366 into multiple groups. For example, as illustrated in FIGS. 4C and 4D, instructions 325 may determine that the remaining chunks specified by group 366 (i.e., K, C, D, and G) would exceed the upper threshold. In response, instructions 325 may split group 366 into a group 376 specifying chunks K, C, and D, and a group 378 specifying chunk G, for example. In this manner, instructions 322 may form a plurality 371 of modified groups, including groups 372, 364, 376, and 378, as illustrated in FIG. 4D. Instructions 322 may form plurality 371 of modified groups so that each of the modified groups (except for possibly one) represents a group of chunks that when grouped into a compression region forms a good-sized compression region. A compression region may be good-sized when a size of it exceeds a lower threshold for compression region size and is less than an upper threshold for compression region size.

In some examples, instructions 327 may further reorder the modified groups of plurality 371. For example, instructions 327 may determine how to reorder the modified groups based on proximity relationship(s) specified by supplemental order information 342 for the respective chunks of the modified groups. In the example of FIGS. 4A-4F, instructions 327 may determine that group 364 should be adjacent to group 378, since pointers 380, 383, and 384 indicate proximity relationships between chunk G and chunks I, L, and M. In such examples, instructions 327 may reorder the modified groups of plurality 371 such that group 364 is adjacent to group 378, as illustrated in FIGS. 4D and 4E. In this manner, instructions 327 may form a plurality 375 of reordered groups, including groups 372, 376, 364, and 373, in that order, as illustrated in FIGS. 4E.

In some examples, instructions 327 may form a respective second compression region including the chunk(s) specified in each of the groups of the plurality 375. For example, instructions 327 may group chunks A, J, and B (of group 372) into a compression region 392 of chunk container 350, may group chunks K, C, and D (of group 376) into a compression region 394 of chunk container 350, may group chunks I, L, and M (of group 364) into a compression region 396 of chunk container 350, and may group chunk G (of group 378) into a compression region 398 of chunk container 350, as illustrated in FIG. 4F. In such examples, instructions 327 may order compression regions of chunk container 350 based on at least one proximity relationship for respective chunks of different compression regions specified by supplemental order information 342 by reordering the modified groups of plurality 371 based on proximity relationships, as described above, and forming compression regions 392, 394, 396, and 398 based on the order and contents of the plurality 375 of reordered groups.

In the example of FIGS. 4A-4F, instructions 327 may replace compression regions 351-358 with compression regions 392, 394, 396, and 398. This replacement may have the effect of deleting chunks E, F, and H, which were considered garbage. In the example of FIG. 4F, supplemental order information 342 may be omitted from chunk container 350 when compression regions 351-358 are replaced. In other examples, chunk container 350 may retain at least some of supplemental order information 342 when compression regions 351-358 are replaced. For example, chunk container 350 may retain pointers 380-384. Additionally, in some examples, for each of compression regions 392, 394, 396, and 398, instructions 328 may compress the chunk(s) of the compression region relative to each other and independent of any other compression region of chunk container 350. That is, instructions 328 may compress each of compression regions 392, 394, 396, and 398 individually and independent of any other compression region. For example, for compression region 392, instructions 328 may compress chunks A. J, and B relative to one another and independent of any compression regions other than compression region 392. In such examples, instructions 328 may compress chunks A, J, and B relative to one another and independent of each other compression region of chunk container 350 (e.g., compression regions 394, 396, and 398),

As described above in relation to system 100, computing device 300 may determine a new grouping of chunks of a chunk container into compression region(s) prior to rearranging the chunks themselves. In such examples, computing device 300 may logically determine a new arrangement of chunks for a chunk container and subsequently rearrange the actual chunks of the chunk container into the determined new arrangement. For example, in the example of FIGS. 4A-4F, instructions 322 may perform the functionalities illustrated in FIGS. 4B-4E logically, without rearranging the chunks themselves. In such examples, after determining the plurality 375 of reordered groups, computing device 300 may then rearrange chunks of chunk container 350 from the arrangement of FIG. 4A to the arrangement of FIG. 4F. In such examples, the ordering and grouping of chunks described in relation to FIGS. 4B-4B may be performed with identifiers (or the like) for the chunks, rather than the chunks themselves. Additionally, compression regions 351-358 of FIG. 4A may each be compressed, as described above, prior to the reordering process described in relation to FIGS. 4A-4F. In such examples, instructions 321 may decompress some or all of the compression regions such that the chunks may be rearranged as illustrated in FIG. 4F. In some examples, instructions 321 may omit the decompression of any compression region remaining the same in the new arrangement or whose chunks are all marked as garbage. In some examples, functionalities described herein in relation to FIGS. 3-4F may be provided in combination with functionalities described herein in relation to any of FIGS. 1-2H and 5-0

FIG. 5 is a flowchart of an example method 500 for grouping similar chunks into a compression region. Although execution of method 500 is described below with reference to computing device 300 of FIG. 3, other suitable systems for execution of method 500 can be utilized (e.g., system 100). Additionally, implementation of method 500 is not limited to such examples.

At 505 of method 500, processing resource 310 may execute instructions 321 to decompress at least one of a plurality of first compression regions 351-358 of a chunk container 344, the first compression regions 351-358 comprising a first plurality 345 of chunks of data, as described above. At 510, processing resource 310 may execute instructions 324 to identify, as similar chunks, chunks of first plurality 345 for which the data of each of the chunks all have in common at least one of a prefix and a suffix, as described above. For example, instructions 324 may identify, as similar chunks, a group 364 of chunks I, L, and M that all have a suffix 2 in common (see FIGS. 4A and 4C). In some examples, at 510, instructions 321 may identify a plurality of groups of similar chunks, as described above in relation to groups 362 and 364 of FIG. 4C. In some examples, at 510, instructions 321 may also identify a group of non-similar chunks, as described above in relation to group 366 of FIG. 4C,

At 515, processing resource 310 may execute instructions 322 to group at least two of the similar chunks of group 364 into a second compression region 396. In the example of FIG. 4F, compression region 396 may include each of the similar chunks I, L. M. In some examples, at 515, instructions 322 may form a plurality of compression regions based on similarity among the data of the chunks of a chunk container. For example, instructions 322 may form the plurality of compression regions based on groups 362, 364, and 366 of FIG. 4G. For example, at 515, instructions 322 may group the chunks of group 362 into a compression region, may group the chunks of group 364 into another compression region, and may group the chunks of group 366 into one or more compression regions. In other examples, at 515, instructions 322 may group chunks of chunk container 350 into a plurality of compression regions based on similarity and supplemental order information 342, as described above in relation to FIGS. 4A-4F.

At 520, processing resource 310 may execute instructions 328 to compress the chunks of second compression region 396 relative to each other and independent of each other compression region of chunk container 344. For example, at 515, instructions 322 may replace compression regions 351-358 of chunk container 344 with compression regions 392, 394, 396, and 398, as described above in relation to FIGS. 4A-4F. In such examples, instructions 328 may compress the chunks of second compression region 396 relative to each other and independent of each of compression regions 392, 394, and 398 of chunk container 344 (i.e., the chunks of those compression regions). Although the flowchart of FIG. 5 shows a specific order of performance of certain functionalities, method 500 is not limited to that order. For example, the functionalities shown in succession in the flowchart may be performed in a different order, may be executed concurrently or with partial concurrence, or a combination thereof. In some examples, functionalities described herein in relation to FIG. 5 may be provided in combination with functionalities described herein in relation to any of FIGS. 1-4F and 6.

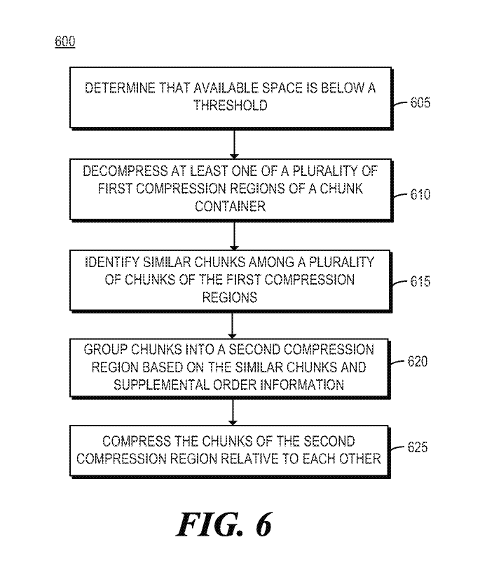

FIG. 6 is a flowchart of an example method 600 for grouping chunks into a compression region based on similarity and supplemental order information. Although execution of method 600 is described below with reference to computing device 300 of FIG. 3, other suitable systems for execution of method 600 can be utilized (e.g., system 100). Additionally, implementation of method 600 is not limited to such examples.

At 605 of method 600, processing resource 310 executing instructions 329 may determine that an amount of available space in a storage unit comprising chunk container 350 (see FIG. 4A) is below a threshold. For example, the storage unit may be chunk container 350, the total storage space allocated for a particular user or other entity (including chunk container 350), the total storage space in the backup system as a whole, or the like, as described above. At 610, processing resource 310 may execute instructions 321 to decompress at least one of a plurality of first compression regions 351-358 of a chunk container 350, the first compression regions 351-358 comprising a first plurality 345 of chunks of data, as described above.

At 615, in response to determining that the available space is below a threshold, processing resource 310 may execute instructions 324 to identify, as a group of similar chunks, chunks of first plurality 345 for which the data of the chunks of the group all have in common at least one of a prefix and a suffix, as described above. In some examples, at 510, instructions 321 may identify a plurality of groups of similar chunks, as described above in relation to groups 362 and 364 of FIG. 4C, and may identify a group 366 of non-similar chunks, as described above in relation to FIG. 4C.

At 620, also in response to determining that the available space is below a threshold, processing resource 310 executing instructions 322 may group a plurality of the chunks of first plurality 345 into a second compression region 392 based on the identified similar chunks and supplemental order information 342 for the first plurality 345 of chunks, as described above in relation to FIGS. 3-4F. In some examples, at 620, instructions 322 may group a plurality of the chunks of first plurality 345 into compression regions 392, 394, 396, and 398, as described above in relation to FIGS. 3-4F.

At 625, processing resource 310 may execute instructions 328 to compress the chunks of second compression region 392 relative to each other and independent of each other compression region of chunk container 350. For example, at 620, instructions 322 may replace compression regions 351-358 of chunk container 350 with compression regions 392, 394, 396, and 398, as described above in relation to FIGS. 4A-4F. In such examples, instructions 328 may compress the chunks of second compression region 392 relative to each other and independent of each of compression regions 394, 396, and 398 of chunk container 350 (i.e., the chunks of those compression regions. In some examples, at 625, instructions 328 may, for each of compression regions 392, 394, 396, and 398, compress the chunk(s) of the compression region relative to each other and independent of any other compression region. Although the flowchart of FIG. 6 shows a specific order of performance of certain functionalities, method 600 is not limited to that order. For example, the functionalities shown in succession in the flowchart may be performed in a different order, may be executed concurrently or with partial concurrence, or a combination thereof. In some examples, functionalities described herein in relation to FIG. 6 may be provided in combination with functionalities described herein in relation to any of FIGS. 1-5.

What is claimed is:

1. A system comprising:
memory to store a chunk container comprising a first plurality of chunks of data in a plurality of first compression regions of the chunk container;
a group engine to group a second plurality of the chunks into a second compression region for the chunk container based on supplemental order information specifying, for at least one pair of the chunks of the first plurality, a proximity relationship for the pair of chunks in an ordered collection of chunks different than and at least partially stored in the chunk container; and
a compression engine to compress the chunks of the second compression region relative to each other and independent of any other compression region of the chunk container.

2. The system of claim 1, wherein:
the group engine is to determine a logical order of the first plurality of chunks based on the supplemental order information; and
the group engine is further to select, as the second plurality of the chunks, a sequence of chunks specified in the logical order.

3. The system of claim 2, wherein:
the supplemental order information includes at least one neighbor pointer associated with a first chunk of the first plurality of chunks and indicating a second chunk of the first plurality of chunks adjacent to the first chunk in the ordered collection of chunks; and
the ordered collection of chunks comprises at least one backup stream, at least a portion of which is stored in the chunk container.

4. The system of claim 2, wherein the supplemental order information includes ordering information of a backup manifest.

5. The system of claim 1, wherein the group engine is further to group the second plurality of the chunks of the first plurality into the second compression region based on similarity among the data of the chunks of the first plurality, and wherein the second plurality includes chunks of the first plurality from different first compression regions of the chunk container.

6. The system of claim 5, wherein the group engine is further to identify similar chunks among the first plurality of the chunks for which the data of each of the similar chunks all have in common at least one of a prefix and a suffix; and
wherein the group engine is further to group at least two of the similar chunks into the second compression region.

7. A non-transitory machine-readable storage medium comprising instructions executable by a processing resource to:
decompress at least one of a plurality of first compression regions of a chunk container, the first compression regions comprising a first plurality of chunks of data;
group a second plurality of the chunks into a second compression region for the chunk container based on similarity among the data of the chunks of the first plurality and based on supplemental order information for the chunks of the first plurality; and
compress the second plurality of the chunks of the second compression region relative to each other.

8. The storage medium of claim 7, wherein:
the instructions to compress comprise instructions to compress the chunks of the second compression region relative to each other and independent of any other compression region of the chunk container; and
the supplemental order information specifies; for at least one pair of the chunks of the first plurality, a proximity relationship for the pair of chunks in an ordered collection of chunks different than and at least partially stored in the chunk container.

9. The storage medium of claim 7, wherein the instructions to group the second plurality of the chunks into the second compression region comprise instructions to:
identify similar chunks among the first plurality of chunks for which the data of each of the similar chunks all have in common at least one of a prefix and a suffix; and
include at least two of the similar chunks in the second compression region.

10. The storage medium of claim 9, wherein the instructions to identify comprise instructions to:
compute, for at least some of the first plurality of chunks, a first hash of a prefix of the data of the chunk and a second hash of a suffix of the data of the chunk; and
determine that a pair of the first plurality of chunks have a prefix in common when the first hashes for the pair of chunks are equivalent and that the pair of chunks have a suffix in common when the second hashes for the pair of chunks are equivalent.

11. The storage medium of claim 7, wherein the instructions to group the second plurality of the chunks into the second compression region comprise instructions to:
identify, based on similarity among the data of the chunks of the first plurality, a group of similar chunks among the first plurality of chunks and a group of non-similar chunks among the first plurality of chunks;
determine that a size of the group of similar chunks does not satisfy a lower threshold for compression region size;
select one of the non-similar chunks based on a proximity relationship between the selected chunk and one of the similar chunks specified in the supplemental order information; and
group the selected chunk and the similar chunks into the second compression region, wherein the second plurality of the chunks comprises the selected chunk and the similar chunks.

12. The storage medium of claim 11, further comprising instructions to:
order compression regions of the chunk container, including the second compression region and another compression region comprising at least one of the first plurality of chunks, based on at least one proximity relationship for respective chunks of different compression regions specified by the supplemental order information.

13. A method comprising:
decompressing at least one of a plurality of first compression regions of a chunk container, the first compression regions comprising a first plurality of chunks of data;
identifying, with a processing resource, similar chunks among the first plurality of chunks for which the data of each of the similar chunks all have in common at least one of a prefix and a suffix;
grouping at least two)f familiar chunks into a second compression region; and
compressing the chunks of the second compression region relative to each other and independent of each other compression region of the chunk container.

14. The method of claim 13, wherein the grouping comprises:
grouping a plurality of the chunks of the first plurality into the second compression region based on the identified similar chunks and supplemental order information for the first plurality of chunks.

15. The method of claim 14, further comprising:
determining that an amount of available space in a storage unit comprising the chunk container is below a threshold;
wherein the identifying the similar chunks and forming the second compression region is performed in response to the determination.
